(19) United States
(12) Patent Application Publication
(10) Pub. No.: US 2021/0001287 A1
(43) Pub. Date: Jan. 7, 2021

(54) GAS-DISSOLVED WATER GENERATING APPARATUS

(71) Applicant: MAW CO., LTD., Incheon (KR)

(72) Inventor: Dong Sik KIM, Seoul (KR)

(21) Appl. No.: 16/771,872

(22) PCT Filed: May 14, 2018
(86) PCT No.: PCT/KR2018/005510

§ 371 Date: Jun. 11, 2020

(30) Foreign Application Priority Data
Dec. 13, 2017 (KR) 10-2017-0171015
Apr. 25, 2018 (KR) 10-2018-0047940

(51) Int. Cl. B01F 7/00; B01F 3/04; B01F 5/04; B01F 15/02; C02F 1/74; C02F 1/78; C02F 1/72; C02F 1/68; B01F 13/10

(52) U.S. Cl. CPC B01F 7/00766; C02F 2103/20; B01F 5/0413; B01F 15/0243; B01F 15/0261; B01F 15/0292; C02F 1/74; C02F 1/78; C02F 1/727; C02F 1/68; B01F 13/1027; B01F 2003/04872; B01F 2003/04879; B01F 2003/04921; B01F 2003/04886; B01F 2003/04893; B01F 2215/0052; B01F 3/04602

(57) ABSTRACT

Provided is a gas-dissolved water generating apparatus in which a pressure pump and a multi-stage mixer are sequentially arranged on at least one conduit; a circulation pipe connecting an inlet side of the pressure pump and a outlet side of the pressure pump is positioned on the conduit; a gas supply unit for supplying a predetermined external gas to one side of the circulation pipe, which is connected to the inlet side of the pressure pump, via a gas supply pipe; the gas supply unit and the circulation pipe are connected through a three-way valve, and the three-way valve is configured to have a structure of a venturi pipe having wide inlet and outlet channels and a narrow interior channel along the circulation pipe, so that a gas supplied from the gas supply unit is independently sucked.

### FIELD OF THE INVENTION

The present invention relates to a gas-dissolved water generating apparatus for dissolving gas in a liquid, and more specifically, relates to a gas-dissolved water generating apparatus that can increase the dissolved ratio of gas such as oxygen, hydrogen, nitrogen, carbon, and ozone in a fluid through mixing and refinement of water (or liquid) and gas.

### BACKGROUND OF THE INVENTION

Recently, various application fields and effects of high-concentration dissolved water (e.g., oxygen water, ozonated water, hydrogen water, nitrogen water, etc.), which has an increased dissolved ratio by dissolving gas in water, are known and as a result, various studies on the technology of dissolving gas in liquid have been conducted. In addition, as the function of nanobubbles as a means for dissolving gas is known, the research on this has been actively conducted.

Conventionally, as an apparatus for dissolving gas in liquid, Korean Patent Publication No. 1792157 discloses a “gas dissolving apparatus for increasing a gas dissolved ratio and generating ultra-fine bubbles”. This patent discloses a gas dissolving apparatus comprises: a hollow hemisphere-shaped outer cylinder; an inner cylinder which is installed inside the outer cylinder and the inside of which is formed to be penetrated; and at least one gas discharge pipe which extends downward from the upper surface of the outer cylinder and discharges a gas in the outer cylinder, wherein gas dissolved bubbles are introduced into the inner cylinder. Here, the gas dissolving apparatus is installed within a processing water in a reaction tank thus to increase a dissolved ratio of gas in the processing water and to further generate ultrafine bubbles containing a gas, whereby the ultrafine bubbles have a low buoyancy so that the residence time in water increases, and the ultrafine bubbles fluctuate even in a small water flow so that the time for the ultrafine bubbles mixed with dissolved material to come into contact with a contact material in water increases, thereby increasing the dissolution and oxidation efficiency of gaseous material mixed with the ultra-fine bubbles in water.

However, with the configuration of the gas dissolving apparatus as described above, it is practically impossible to achieve nano-level ultrafine bubbles, and even if ultrafine bubbles are generated, there is a limit to actually increase a dissolved ratio of gas.

In addition, Korean Patent Publication No. 1153290 discloses an apparatus for increasing the amount of nanobubbles dissolved in a liquid comprising: a low pressure tank and a high pressure tank, wherein bottoms of the low pressure tank and of the high pressure tank are connected by a high pressure generating pipe and a low pressure generating pipe, and the high pressure generating pipe is provided with a motor and a bubble generator and the low pressure generating pipe is provided with a low pressure generating means. With the above configuration, microbubbles and nanobubbles are formed to be dissolved together in the high pressure tank by the motor and the bubble generator. However, liquid in the high-pressure tank in which the microbubbles and nanobubbles are dissolved together is delivered to the low-pressure tank through the low-pressure generating pipe, and the microbubbles are floated and collapsed and only the nanobubbles remain dissolved, and then liquid in which only the nanobubbles are dissolved is again delivered to the high-pressure tank through the motor and the bubble generator via the high-pressure generating pipe. By repeating the routine described above, as the microbubbles are removed from a liquid, eventually the existence space of the nanobubbles can increase in a liquid and the amount of dissolved nanobubbles in a liquid can increase thereby increasing the amount of dissolved bubbles in a liquid.

However, such an apparatus for increasing the amount of dissolved nanobubbles in a liquid generally requires a large-capacity pump power and has a disadvantage in that the installation space of the auxiliary equipment according to the high pressure tank and the low pressure tank is widened and the installation cost is also increased.

In addition, this apparatus adopts a way of increasing the dissolved amount of gas by utilizing hydraulic pressure within the pressure tank. Therefore, in general, the dissolved amount of gas is not more than 50%, and there is a problem that a lot of work time is required.

In fact, according to the applicant's research, the dissolved ratio can be maximized only when the cavitation pressure applied in multiple steps and generation of nanobubbles are simultaneously achieved in the water.

### DETAILED DESCRIPTION OF THE INVENTION

### Technical Problem

The present invention was developed to solve the above problems, and the object of the invention is to provide a gas-dissolved water generating apparatus capable of further increasing a gas dissolved ratio in water (or liquid) by providing multi-stage cavitation pressure and a turbulence phenomenon to a mixed fluid of water (or liquid) and gas, thereby accelerating the mixing and refinement of the fluid to generate nanobubbles.

### Means for Solving the Problem

One aspect of the present invention for achieving the above object provides a gas-dissolved water generating apparatus in which a pressure pump and a multi-stage mixer are sequentially arranged on at least one conduit; a circulation pipe connecting an inlet side of the pressure pump and a outlet side of the pressure pump is positioned on the conduit; a gas supply unit for supplying a predetermined external gas to one side of the circulation pipe, which is connected to the inlet side of the pressure pump, via a gas supply pipe; the gas supply unit and the circulation pipe are connected through a three-way valve, and the three-way valve is configured to have a structure of a venturi pipe having wide inlet and outlet channels and a narrow interior channel along the circulation pipe, so that a gas supplied from the gas supply unit is independently sucked.

According to the present invention, the multi-stage mixer includes a mixing unit having a meshing structure of a rotor and a stator around a motor shaft, wherein the rotor and the stator have a multi-layer structure in which teethed blades are formed on the rotor and the stator to correspond to each other and are stacked with a constant thickness, teethed blades of the rotor and the stator includes a plurality of short-toothed portions and a plurality of long-toothed portions protruding at regular intervals between the respective short-toothed portions, respectively. The teethed blades are continuously stacked; the long-toothed portions of the rotor correspond to the short-toothed portions of the stator, the long-toothed portions of the stator correspond to the short-toothed portions of the rotor, and teethed blades of the rotor and the stator have a coupling shape interleaved with each other at regular intervals between the ends of the long-toothed portions thereof. A fluid supplied by the pressure pump can flow from an inlet provided on one side of the lower portion of the mixing unit of the multi-stage mixer to an outlet provided on the other side of the upper portion thereof in the corresponding direction, and in order to guide this fluid flow, one or more guide blades may be disposed at positions on the motor shaft adjacent to the inlets and outlets at a predetermined distance in the vertical direction of the rotor. The mixing unit has a space portion having a predetermined size on an inlet side, and the space portion is formed by installing at least one layer of teethed blades of a predetermined radius on the motor shaft at a position spaced a predetermined distance from a coupling portion of the rotor and stator in the mixing unit. As a another aspect of the present invention, the mixing unit has the rotor configured in a truncated cone shape in which the radius of the long-toothed portion and the short-toothed portion is reduced stepwise, and the stator configured as an inverted truncated cone shape in which the radius of the long-toothed portion and the short-toothed portion increases stepwise in correspondence with the truncated cone-shaped rotor.

In addition, according to the present invention, wherein the rotor has a plurality of teeth formed at regular intervals along the outer circumferential end portions of the respective teethed blades, and the stator has a plurality of teeth formed at regular intervals along the inner circumferential end portions of the respective teethed blades; and wherein the teeth formed on the outer or inner circumferential surface of the respective teethed blades of the rotor and the stator have at least one side surface of side surfaces facing each other during relative rotation of the rotor and the stator, the teeth having the one side surface inclined at a predetermined angle, and the respective teeth of the long-toothed portion and the short-toothed portion of the rotor have at their outer circumferential end portions grooves of a predetermined radius.

In addition, according to the present invention, wherein a partition unit of a predetermined shape is installed on the outlet-side conduit of the multi-stage mixer to further increase a gas dissolved ratio in the fluid discharged from the mixing unit, the partition unit has at least two or more partition walls therein, one or more holes are perforated in each of these partition walls, and the holes are arranged in the front and rear partition walls not to face each other; and wherein a storage tank of a predetermined size is installed on the outlet-side conduit of the multi-stage mixer and the fluid having passed through a partition unit is stored in the storage tank, and a plurality of electrode rods are installed inside the storage tank, wherein each of the electrode rods is connected to (+) and (−) terminals of DC power, respectively.

In addition, according to the present invention, wherein a dispersion prevention housing is installed in a discharge-side space of the upper portion of the mixing unit, the dispersion prevention housing surrounding the space with a certain diameter and being intended to prevent excessive expansion and dispersion of the fluid, wherein the dispersion prevention housing is in communication with the outlet disposed at the upper portion of the mixing unit and an outlet-side conduit extending therefrom, and includes an intermediate portion having a space having a certain size in the circumferential direction thereof in correspondence to the outlet; wherein a guide blade on the motor shaft for guiding a fluid flow is placed in the intermediate portion to be operable; wherein a first mixing ejector which includes a short-toothed portion at a location connected to the circulation pipe and a long-toothed portion at a location connected to the inlet side pipe of the pressure pump is installed as a substitute for the three-way valve; wherein a second mixing ejector which includes a short-toothed portion at a location connected to the final end or outlet side of the outlet-side conduit and a long-toothed portion at a location in the corresponding direction of the short-toothed portion is further comprised; wherein the first and second mixing ejectors has a structure in which an inner diameters thereof are gradually enlarged from the short-toothed portion to the long-toothed portion; wherein a connection portion connected to the gas supply pipe is formed at one side of the short-toothed portion to provide a space portion having a predetermined size traversing the end portion of the short-toothed portion from the connection portion; and wherein one or more quantum energy generators are installed on the outlet-side conduit between the multi-stage mixer and the partition unit, and the quantum energy generator is configured by installing one or more magnetic field coils inside a pipe.

Meanwhile, a gas which is supplied according to the present invention can be selected from at least one of a variety of gas groups including air, oxygen (O₂), nitrogen (N₂), ozone (O₃), carbon dioxide (CO₂), and the fluid may be composed of oxygen-dissolved water, nitrogen-dissolved water, ozone-dissolved water, and carbon dioxide-dissolved water as needed. In addition, when the rotor is rotated at a high speed over a certain level while the mixed fluid of water (or liquid) and gas is pressurized with a pump at a pressure of greater than or equal to 4 kg/cm², the fluid is refined to less than or equal to 5 microns and at the same time is mixed to further increase a gas dissolved ratio in a fluid.

### The Effect of the Invention

According to the above-described features, the present invention provides a multi-stage cavitation pressure to a mixed fluid of water (or liquid) and gas by using the steps of toothed blade s in a mixer and the lateral inclination angles of the protruding teeth, and at the same time, inducing a turbulence phenomenon, a change of flow velocity and water pressure and accelerating mixing and refinement of the fluid, to generate nanobubbles. Therefore, it is possible to further increase the dissolved ratio of gas such as oxygen, hydrogen, nitrogen, carbon, ozone, etc. in the liquid.

### BRIEF DESCRIPTION OF THE DRAWINGS

FIG. 1 is a view showing the basic configuration of a gas-dissolved water generating apparatus of the present invention,

FIGS. 2A and 2B are an enlarged view showing an embodiment of the mixing unit in the multi-stage mixer according to FIG. 1 and a modification thereof;

FIGS. 3A and 3B are a cross-sectional view showing a first embodiment of the coupling structure of the rotor and the stator at one end of the mixing unit according to FIG. 2,

FIGS. 4A and 4B are a cross-sectional view showing a first embodiment of the coupling structure of the rotor and the stator at the other end of the mixing unit according to FIG. 2,

FIGS. 5A and 5B are a cross-sectional view showing a second embodiment of the coupling structure of the rotor and the stator at one end of the mixing unit according to FIG. 2,

FIGS. 6A and 6B are a cross-sectional view showing a second embodiment of the coupling structure of the rotor and the stator at the other end of the mixing unit according to FIG. 2,

FIG. 7 is an enlarged view showing an embodiment of the partition unit of FIG. 1,

FIG. 8 is an enlarged view showing another embodiment of the partition unit of FIG. 1;

FIG. 9 is another embodiment of the gas-dissolved water generating apparatus of the present invention,

FIG. 10 is another embodiment of the gas-dissolved water generating apparatus of the present invention,

FIG. 11 is an enlarged view of the multi-stage mixer of FIG. 10 having a modified form of the mixing unit according to FIG. 2,

FIG. 12 is an enlarged view of the first mixing ejector of FIG. 10, which is a modified form of the three-way valve according to FIG. 1;

FIG. 13 is an enlarged view of the second mixed ejector of FIG. 10, which is further provided in the gas-dissolved water generating apparatus of the present invention,

FIG. 14 is an enlarged view of a quantum energy generator further provided in the gas-dissolved water generating apparatus of the present invention.

### MODE FOR CARRYING OUT THE INVENTION

Hereinafter, preferred embodiments of the present invention will be described with reference to the accompanying drawings.

In the following embodiments, parts excluding inevitable parts in the explanation of the invention, the illustration and explanation thereof are omitted, and the same reference numerals are assigned to the same or similar elements throughout the description and detailed explanation thereof will be omitted without repetition.

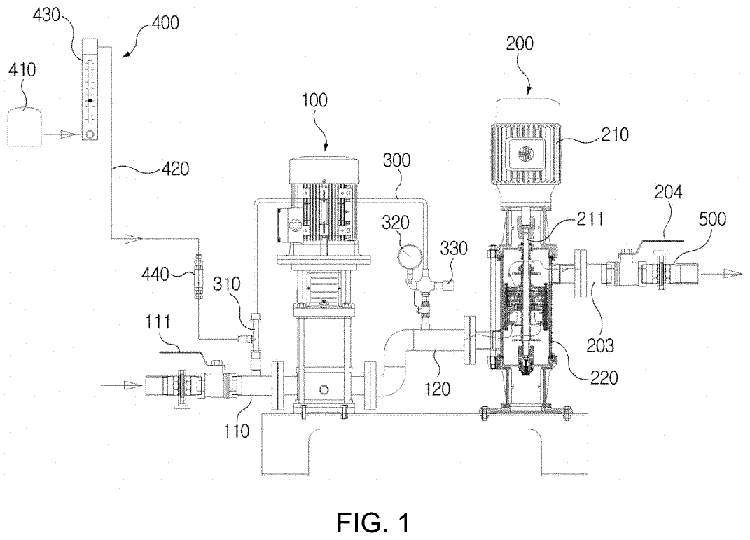

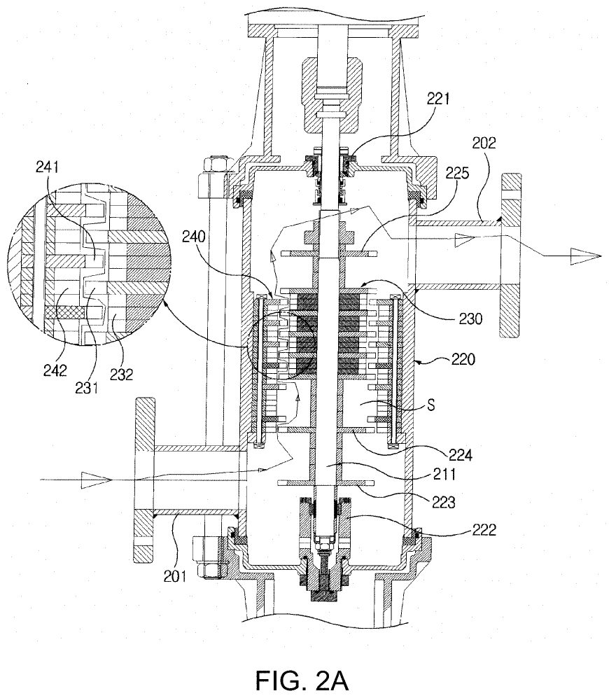

FIG. 1 is a view showing a basic configuration of a gas-dissolved water generating device according to the present invention, and FIG. 2 is enlarged views an embodiment of a mixing unit in a multi-stage mixer according to FIG. 1 and a modification thereof.

Gas-dissolved water generating apparatus of the present invention is intended to be used for improving water quality of reservoirs, aquariums, or aquafarms, etc., or providing drinking water, washing water, or sterilized water, etc. by generating nanobubbles by selectively refining and mixing gases such as air, oxygen (O₂) , nitrogen (N₂) , ozone (O₃) , and carbon dioxide (CO₂) in the fluid to increase gas dissolved ratio.

According to FIG. 1, a gas-dissolved water generating apparatus is provided in which a pressure pump 100 and a multi-stage mixer 200 are sequentially arranged on at least one conduit; a circulation pipe 300 connecting an inlet side of the pressure pump 100 and a outlet side of the pressure pump 100 is disposed on the conduit; and a gas supply unit 400 for supplying an external gas is connected to one side of the circulation pipe 300 which is connected to the inlet side of the pressure pump 100.

The circulation pipe 300 recovers a portion of high pressure water (or liquid) compressed by the pressure pump 100 and transfers it to the inlet-side conduit 110 of the pressure pump, which is a low pressure portion. As described above, a gas supply unit 400 for supplying external gas is connected to one side of the circulation pipe 300. Here, at least one may be selected from various gases including air, oxygen (O₂), nitrogen (N₂), ozone (O₃), and carbon dioxide (CO₂) and the like as the external gas.

The gas supply unit 400 includes a storage tank or gas generation means 410 of selected gases, and a gas supply pipe 420 connecting the circulation pipe 300 and the storage tank or gas generation means 410. The gas supply pipe 420 may be provided with a flow control valve 430 for regulating the amount of gas supply from the storage tank or gas generating means 410, and a check valve 440 for preventing backflow of gas or high pressure water. In addition, the gas supply pipe 420 and the circulation pipe 300 are connected through a three-way valve 310, and the three-way valve has a structure of a Venturi pipe with a wide inlet and outlet and a narrow inner part along the circulation pipe 300. In this configuration, water (or liquid) transferred to the inlet-side conduit 110 of the pressure pump, which is the low-pressure portion, along the circulation pipe 300, has a sudden drop in pressure and a greatly increased flow rate while passing through the bottleneck of the venturi pipe. Accordingly, the gas supplied from the gas supply unit 400 through the gas supply pipe 420 is mixed with water (or liquid) inside the circulation pipe 300 by being independently sucked into the circulation pipe without being forcibly pushed therein with a separate power. Here, the supplied gas may be at least one selected from the gas group including air, oxygen (O₂), nitrogen (N₂), ozone (O₃), carbon dioxide (CO₂), etc. Further, oxygen-dissolved water, nitrogen-dissolved water, ozone-dissolved water, carbon dioxide-dissolved water, and the like, may be generated according to the application.

The inlet-side conduit 110 of the pressure pump 100 and the outlet-side conduit 203 of the multi-stage mixer 200 are provided with opening/closing valves 111 and 204, respectively, to control the flow rate of supply water or discharge fluid and to open and close the flow path. In addition, the end portion of the circulation pipe 300, that is, the connection portion of a outlet-side conduit 120 of the pressure pump 100 and the circulation pipe 300 may be provided with a pressure gauge (hydraulic sensor; 320) for measuring and sensing the pressure of the fluid and a safety sensor 330 for applying a signal indicating no water.

The operating principle of the multi-stage mixer 200 consists in repeatedly hitting air, oxygen (O₂), nitrogen(N₂), ozone (O₃), carbon dioxide (CO₂), or etc. in a mixed fluid (hereinafter referred to as “fluid”) of water (or liquid) and gas supplied from a pressure pump 100 in a high pressure state, by means of a number of teethed blades, and at this time, using cavitation (cavitation) generated in the fluid, thereby generating bubbles. For this operation, the multi-stage mixer 200 has a structure in which a plurality of teethed blades are formed on both the shaft (motor shaft 211) of a motor 210 and the inner wall surface of and a housing (mixing unit 220) such that these teethed blades correspond to each other. In this description, since the teethed blades provided on the motor shaft 211 can be rotated by driving the motor 210, this is referred to as a “rotor 230” for convenience, and since the teethed blades formed on the inner wall surface of the housing (hereinafter referred to as a “mixing unit”; 220) maintain a fixed state, this is referred to as a “stator 240” for convenience.

Both ends of the motor shaft 211 are supported by underwater bearings 221 and 222 provided at upper and lower ends of the mixing unit 220 including the meshing structure of the rotor 230 and the stator 240, and this configuration can prevent the motor shaft 211 from being distorted due to inertia.

The fluid supplied by the pressure pump 100 can flow from an inlet 201 provided on one side of the lower side of the mixing unit 220 of the multi-stage mixer 200 to an outlet 202 provided on the other side of the upper side thereof in the corresponding direction. To guide this fluid flow, one or more guide blades 223 and 225 may be disposed at positions adjacent to the inlets 201 and outlets 202 on the motor shaft 211 at a predetermined distance in the vertical direction of the rotor 230. In addition, the cavitation pressure in the fluid carried by the guide blades 223 and 225 increases by the interaction of the rotor 230 and the stator 240 described below, that is, relative rotation, and such a cavitation causes bubbles to be generated and the gas dissolved ratio in the fluid to be increased.

The rotor 230 and the stator 240 have a multi-layer structure in which the respective teethed blades are formed on the rotor 230 and the stator 240 to correspond to each other and are stacked with a constant thickness, wherein teethed blades on the rotor 230 and the stator 240 includes a plurality of short-toothed portions 232 and 242 which are continuously stacked with a constant radius and a plurality of long-toothed portions 231 and 241 protruding at regular intervals between the respective short-toothed portions with a constant radius. Preferably, the long-toothed portions 231 of the rotor 230 correspond to the short-toothed portions 242 of the stator 240, and the long-toothed portions 241 of the stator 240 correspond to short-toothed portions 232 of the rotor 230. A coupling structure of the long-toothed portions 231 and 241 of the rotor and the stator is formed in which ends of the long-toothed portions of the rotor and the stator are interposed with each other with adjacent ones of the ends disposed at the regular intervals in the vertical direction. The rotor 230 and the stator 240 are preferably formed with a flow path of a predetermined interval so that the fluid can pass therebetween.

According to the drawings, the rotor 230 and the stator 240 are shown in a form in which a long-toothed portion of the single layer protrudes relative to a short-toothed portion of three layers, but the present invention is not limited thereto. Of course, it is possible to provide a stacking ratio of teethed blades constituting the long-toothed portions 231 and 241 and short-toothed portions 232 and 242 in a ratio of 1 to 1, 2 to 1, 2 to 2, 3 to 2, or more.

When the motor 210 is driven in such a structure, the rotor 230 rotates, thereby causing the relative rotation of the long-toothed portions 231 and 241 and the short-toothed portions 242 and 232 between the rotor 230 and the stator 240, and at this time, gases that are within the fluid flowing along the flow path between the rotor 230 and the stator 240 are minutely mixed while being finely divided.

For example, when the rotor 230 is rotated at a high speed over a certain level in a state in a state in which a mixed fluid of water (or liquid) and gas is pressurized with a pump at a pressure of greater than or equal to 4 kg/cm², the fluid is miniaturized to less than or equal to 5 micron, and gas dissolved ratio in the fluid can be further increased.

In addition, the long-toothed portions 231 and 241 and the short-toothed portions 232 and 242 of the rotor 230 and the stator 240 may be provided with at least a portion of their tips in a sharp blade shape structure. Here, the sharp tip portions may provide the effect of hitting gas in a fluid and simultaneously breaking the bubbles generated in the first stage more finely. Through this, the mixing of water (or liquid) and gas becomes smoother, and at the same time, the bubbles may be further broken into micron (10⁻⁶ m) or nanometer (10⁻⁹ m) sized ultrafine bubbles. In addition, the mixing unit 220 including the meshing structure of the rotor 230 and the stator 240 in the multi-stage mixer 200 may form a space portion S having a predetermined size on the inlet side thereof. The space portion S is configured to install at least one layer of toothed blade 224 of a predetermined radius on the motor shaft 211 at a position spaced a predetermined distance from the coupling part of the rotor 230 and the stator 240 in the mixing unit 220, and the space portion S increases the fluid pressure and accelerates the cavitation phenomenon in the fluid, thereby providing the effect of further activating bubble generation. In the space portion S, at least one layer of a toothed blade having a predetermined size corresponding to the toothed blade 224 may be further installed on the inner wall of the mixing unit 220 to interact with the toothed blade 224.

As a modified example, according to FIG. 2A, the mixing unit 220′ may include a rotor 230 in a shape in which the radius of the long-toothed portion 231 and the short-toothed portion 232 is gradually reduced, for example a truncated cone shape. In this case, the stator 240 may be configured as a shape, for example an inverted truncated cone shape in which the radius of the long-toothed portion 241 and the short-toothed portion 242 increases stepwise in correspondence with the truncated cone-shaped rotor 230.

The structure of the mixing unit 220′ having the truncated cone-shaped rotor arrangement and the corresponding inverted truncated cone-shaped stator arrangement allows for maximum cavitation while the fluid gradually moves from the wide cross-sectional space of the rotor 230 to the narrow cross-sectional space thereof, thereby further increasing the gas dissolved ratio in the fluid.

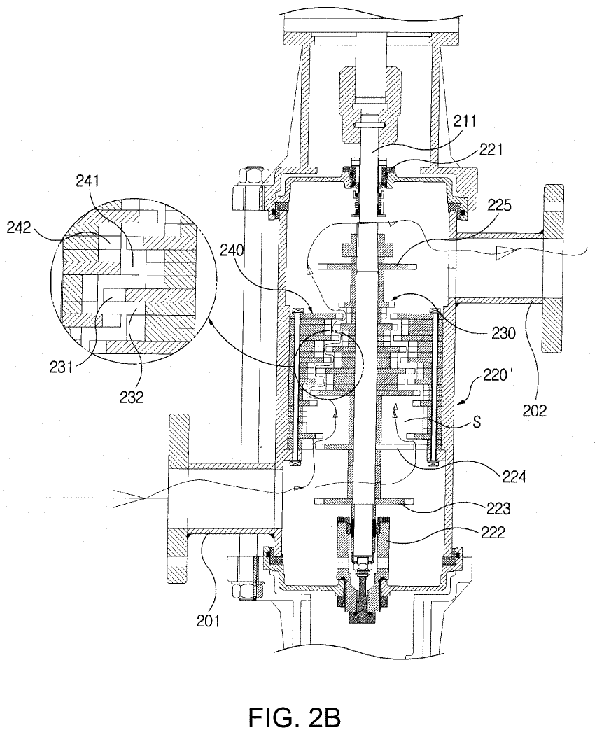

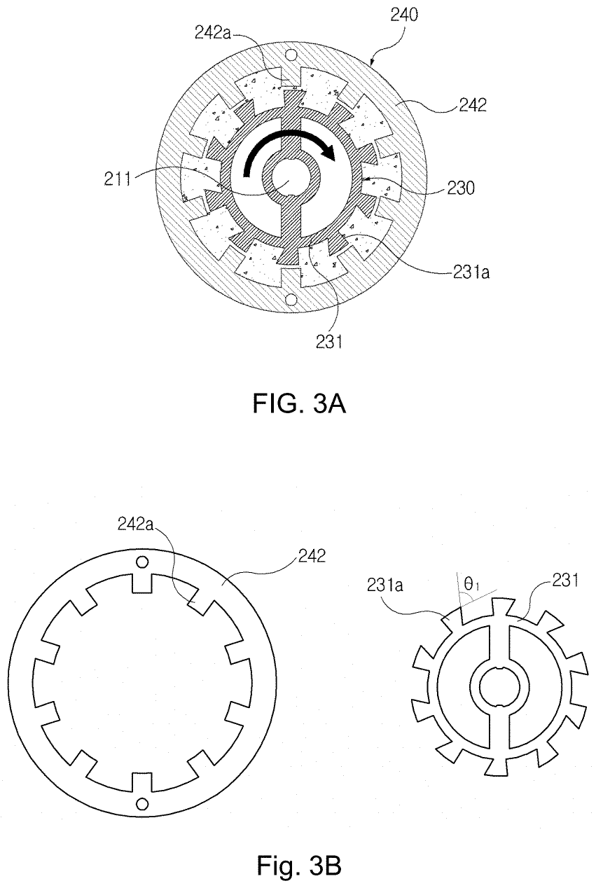

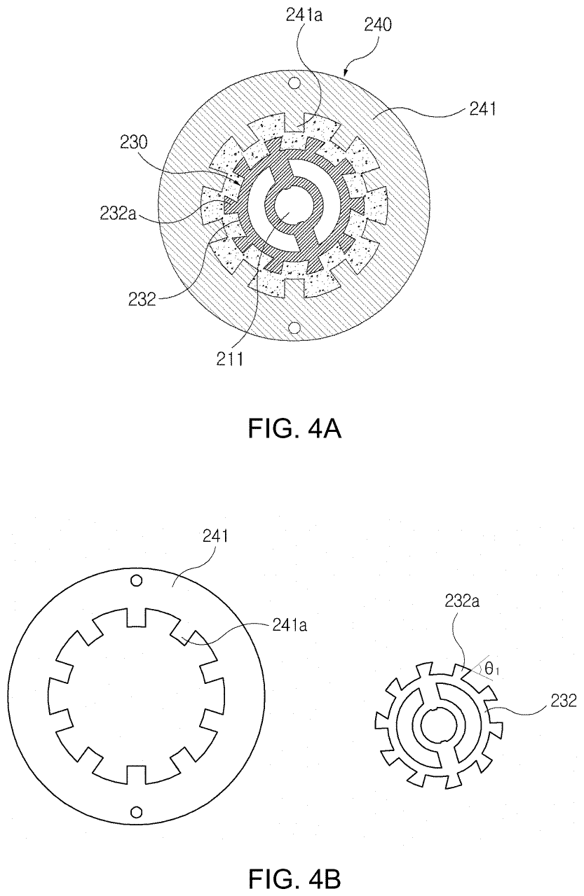

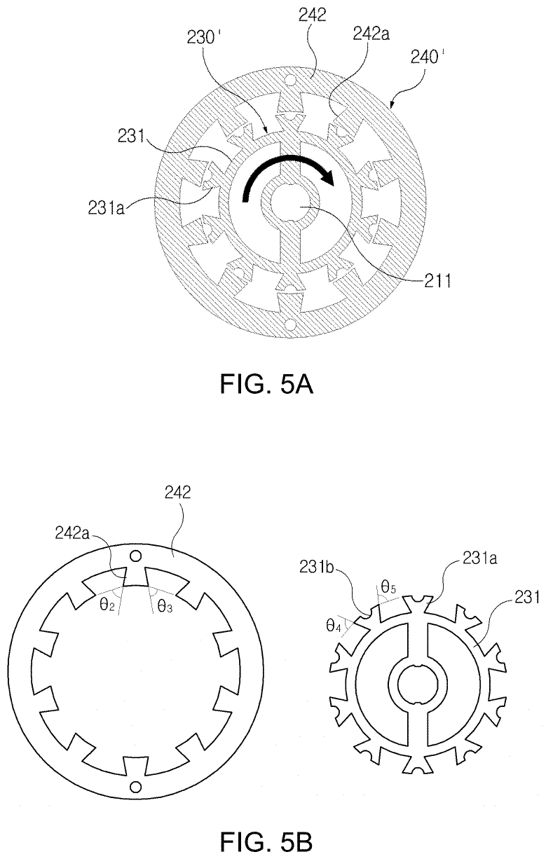

FIGS. 3 to 4 and 5 to 6 show different coupling structures of the rotor and the stator constituting the mixing unit of the multi-stage mixer according to FIG. 2, and FIGS. 3a and 5a are cross sectional views of a combined rotor and stator at one end of the mixing unit, FIGS. 4a and 6a are cross sectional views of a combined rotor and stator at the other end of the mixing unit, and FIGS. 3b to 6b are exploded views of the coupling structures according to FIGS. 3a to 6a, respectively.

The rotor 230 has a plurality of teeth 231a and 232a formed at regular intervals along the outer circumferential end portions of the respective teethed blades 231 and 232, and the stator 240 has a plurality of teeth 241a and 242a formed at regular intervals along the inner circumferential end portions of the respective teethed blades 241 and 242. In addition, the teeth 231a and 232a, 241a and 242a formed on the outer or inner circumferential surface of the respective teethed blades of the rotor 230 and the stator 240 may have a structure inclined at a predetermined angle (for example, 15 to 45 degrees) in at least one side of end sections corresponding each other during relative rotation of the rotor and the stator. As described above, the inclination angles which are formed on facing end sections of the respective teeth, are intended to maximize a turbulence phenomenon of the fluid and the occurrence of cavitation caused thereby during the rotation at high speed, thereby increasing the dissolved amount of gas in the fluid and enabling the generation of microbubbles.

Referring to FIGS. 3A and 3B, the rotor 230 is indicated by a long-toothed portion 231 of the toothed blade, and the stator 240 is indicated by a short-toothed portion 242 of the toothed blade. In this coupling structure, the teeth 231a formed at the outer circumferential end portion of the long-toothed portion 231 of the rotor 230 have inclined lateral surfaces having a predetermined angle θ₁ in correspondence to lateral surfaces of the teeth 242a of the stator 240 during relative rotation. The angle θ₁ ranges from 15 to 45 degrees, preferably 30 degrees.

Referring to FIGS. 4A and 4B, the rotor 230 is indicated by a short-toothed portion 232 of the toothed blade, and the stator 240 is indicated by a long-toothed portion 241 of the toothed blade. In this coupling structure, the teeth 232a formed at the outer circumferential end portion of the short-toothed portion 232 of the rotor 230 have inclined lateral surfaces having a predetermined angle θ₁ in correspondence to lateral surfaces of the teeth 241a of the stator 240 during relative rotation. The angle θ₁ ranges from 15 to 45 degrees, preferably 30 degrees.

Referring to FIGS. 5A and 5B, the rotor 230′ is indicated by a long-toothed portion 231 of the toothed blade, and the stator 240′ is indicated by a short-toothed portion 242 of the toothed blade. In this coupling structure, the teeth 231a formed at the outer circumferential end portion of the long-toothed portion 231 of the rotor 230′ and the teeth 242a formed at the inner circumferential end portion of the short-toothed portion 242 of the stator 240′ have inclined lateral surfaces having the respective predetermined angles θ₄ and θ₅, θ₂ and θ₃ which at least faces each other during relative rotation. The angles θ₄ and θ₅, θ₂ and θ₃ ranges from to 45 degrees, preferably 30 degrees. In addition, the respective teeth 231a of the long-toothed portion 231 of the rotor 230′ may have grooves 231b of a predetermined radius at their outer circumferential end portions.

Referring to FIGS. 6A and 6B, the rotor 230′ is indicated by a short-toothed portion 232 of the toothed blade, and the stator 240′ is indicated by a long-toothed portion 241 of the toothed blade. In this coupling structure, the teeth 232a formed at the outer circumferential end portion of the short-toothed portion 232 of the rotor 230′ and the teeth 241a formed at the inner circumferential end portion of the long-toothed portion 241 of the stator 240′ have inclined lateral surfaces having the respective predetermined angles θ₄ and θ₅, θ₂ and θ₃ which at least faces each other during relative rotation. Here, the inclination angles θ₄ and θ5, θ₂ and θ₃ ranges from 15 to 45 degrees, preferably 30 degrees. In addition, the respective teeth 232a of the short-toothed portion 232 of the rotor 230′ may have grooves 232b of a predetermined radius at their outer circumferential end portions.

Meanwhile, the inclination angle of the lateral surfaces of the teeth shown in FIGS. 3 to 6 may be determined in consideration of the length or width of the circumferential surface of each toothed blade, and a flow amount or flow rate of the mixed fluid introduced. Accordingly, the inclination angle of each inclined portion may be made the same or different angles according to the factors as described above.

From such a configuration, turbulence of the mixed fluid that splashes against the teeth during relative rotation is promoted, and thus, the occurrence of cavitation caused thereby may expedite the generation of microbubbles. In this case, the inclination angles of the teeth formed on the respective teeth blades of the rotor 230 and the stator 240 are preferably configured to be equal. However, they are not limited thereto and these inclination angles can be determined considering various factors such as the size or length of each toothed blade, the behavior of the mixed fluid, and the like.

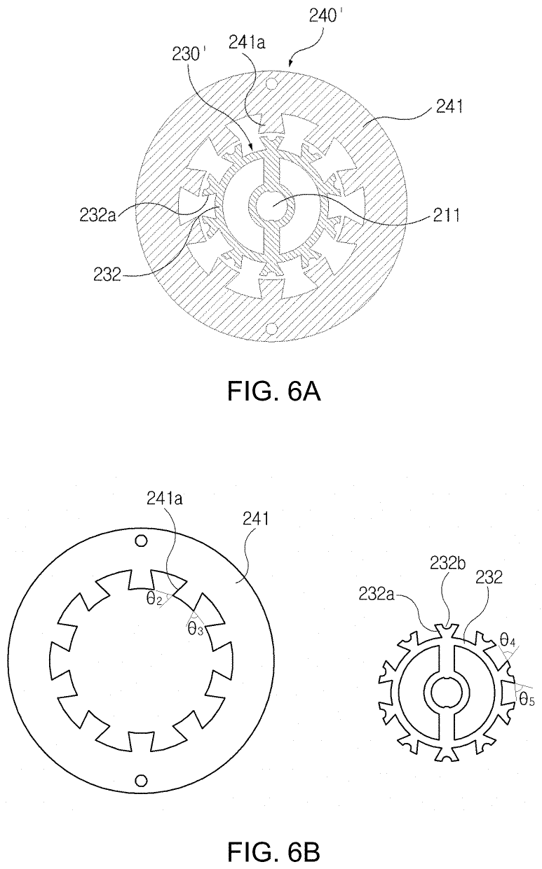

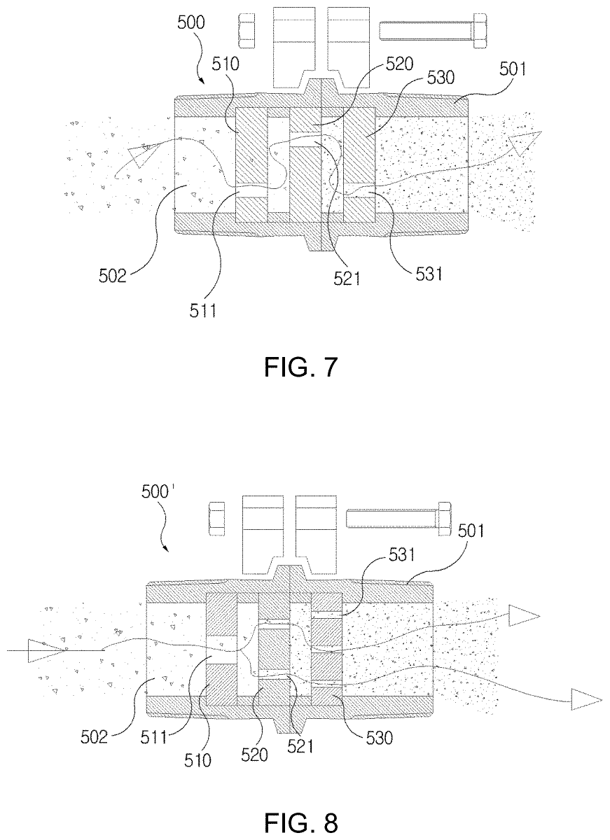

FIGS. 7 and 8 are enlarged views of a first embodiment and a second embodiment of a partition unit according to FIG. 1, and referring to FIG. 1, a partition unit 500 of a predetermined shape may be installed on a conduit 203 on the outlet side of the multi-stage mixer 200 in order to further increase the gas dissolved ratio in the fluid discharged from the mixing unit 220. The partition unit 500 has at least two or more partition walls therein, and one or more holes may be perforated in each of these partition walls. Preferably, these holes are arranged in the front and rear partition walls not to face each other.

Illustratively, according to the structure of the partition unit 500 of FIG. 7, three partition walls 510, 520, and 530 that block the flow path 502 inside the housing 501 are formed at regular intervals. The holes 511, 521, and 531 are perforated in the partition walls 510, 520, and 530, respectively such that the holes do not face each other. In addition, according to the structure of the partition unit 500′ of FIG. 8, three partition walls 510, 520 and 530 that block a flow path 502 are formed inside a housing 501 at regular intervals, and one hole 511 of large diameter is perforated in the first partition wall 510, two holes 521 of medium diameter are perforated in the second partition wall 520, and three holes 531 of small diameter are perforated in the third partition wall 530. And these holes are disposed such that they do not face each other. According to this structure, the fluid discharged from the multi-stage mixer 200 flows sequentially through holes 511, 521 and 531 inside the partition unit. During this flow process of the fluid, the fluid collides with each of the partition walls 510, 520, 530 and thereby gas molecules in the fluid are more and more miniaturized and homogenized. In addition, since the partition walls are spaced apart from each other, a space portion is formed between them, and the space portion rapidly drops the pressure of the fluid passing therethrough to cause vortex, and at the same time, accelerates the cavitation phenomenon, thereby miniaturizing gas molecules in the fluid to a nano size and more uniformly mixing them, as a result, the dissolved ratio of gas in the fluid can be further increased.

Although not shown in the drawings, the partition unit may be provided to form an arrangement of the holes passing through the partition walls in which a plurality of holes of small diameters leads to a plurality of holes of large diameters, or a repetition of the arrangement. In this case, due to the pressure change, the bubbles are further miniatured and homogenized, and the dissolved ratio further increases, while a discharge fluid passes through from the small-diameter holes to the large-diameter holes.

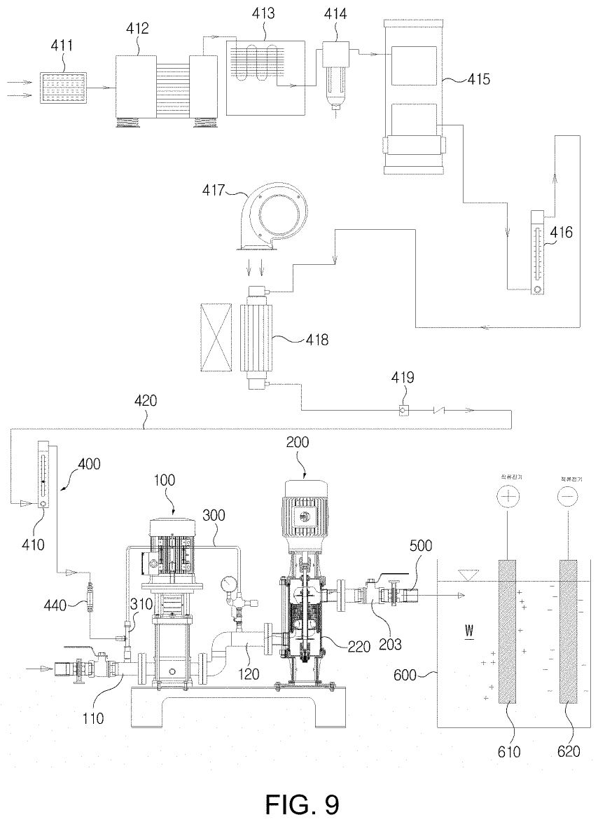

FIG. 9 shows another embodiment of the gas-dissolved water generating apparatus according to FIG. 1, in which a storage tank 600 of a predetermined size may be configured to be installed on the outlet-side conduit 203 of the multi-stage mixer 200 and the fluid having passed through a partition unit 500 may be configured to be stored in the storage tank. In addition, a plurality of electrode rods 610 and 620 are installed inside the storage tank 600, and each of the electrode rods 610 and 620 is connected to (+) and (−) terminals of DC power, respectively. Therefore, a gas-dissolved fluid may be changed to have other more powerful properties, namely, decomposition, purification, decolorization, or deodorization by applying current, and may be used for the respective applications.

In addition, the storage tank or gas generating means 410 of FIG. 1 described above with reference to FIG. 9 is configured to store air, oxygen (O₂) , nitrogen (N₂) , ozone (O₃), carbon dioxide (CO₂), etc. in the case of the storage tank and is configured to withdraw the required gas from the inside of the tank and supply it to the pressure pump 100 through the circulation pipe 300, if necessary, whereas the storage tank or gas generating means 410 may be configured to generate and provide the required gas from external gas in the case of the gas generating means. To this end, the gas generating means 410 may have a configuration in which an air filter 411, an air compressor 412, an air dryer 413, a water eliminator 414, a gas generator 415, a flow regulator 416, a blower 417, a discharge tube 418, and a check valve 419 are selectively arranged on the gas supply pipe 420.

According to the gas generating means 410 having this configuration, impurities are removed by passing air in the atmosphere through the air filter 411, and the air is then pressurized by the air compressor 412 to a predetermined pressure or more. Afterward, moisture in the air is removed by the air dryer 413 and the remaining moisture is once again discharged by the water remover 414. Subsequently, the dried air is passed through the gas generator 415 to generate a desired gas, that is, air, oxygen (O₂), nitrogen (N₂), ozone (O₃), carbon dioxide (CO₂), etc. and to adjust the flow rate of the supplied gas by a flow regulator 416. Afterward, the gas is blown to the blower 417 to transform it into ozone (O₃) or other gases in the discharge tube 418, and then is transferred through the check valve 419 and the flow control valve 430 to the circulation pipe 100 to be mixed with water (or liquid) inside the circulation pipe.

Meanwhile, in the case of using the gas-dissolved water generating apparatus according to the present invention, the gas dissolved ratio in the liquid can be very high, so that a high concentration of dissolved liquid can be produced and can be utilized as anion-rich hydrogen water, drinking water such as oxygen water or carbonated water. In particular, ozone water can be generated by dissolving ozone (O₃) gas, and usually has a very high ozone-dissolved ratio. Therefore, ozone water has a strong sterilizing power and has the ability to decompose, deodorize, and decompose, and thus can be used in water purification or wastewater treatment. In addition, the gas-dissolved water generating apparatus according to the present invention can generate a fluid having a desired use and dissolved ratio with a single apparatus as compared to a conventional hydrogen water generating apparatus or an oxygen water generating apparatus that requires a large amount of the facility cost, to reduce this cost to a ¼ level compared to other apparatuses.

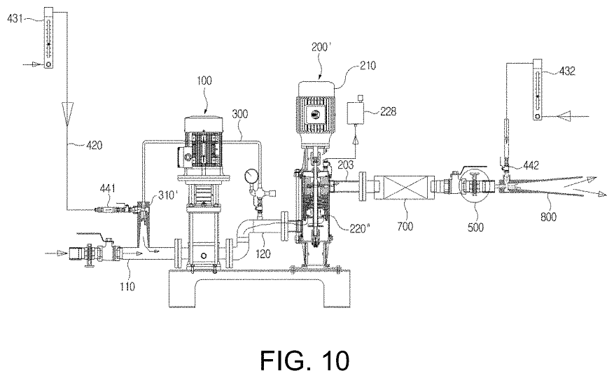

FIG. 10 is another embodiment of the gas-dissolved water generating apparatus of the present invention. The gas-dissolved water generating apparatus in the present embodiment has a basic configuration, as shown in FIGS. 1 and 9, in which a pressurize pump 100 and a multi-stage mixer 200′ are sequentially arranged at least one conduit; a circulation pipe 300 for connecting the outlet side and the inlet side of the pressure pump 100 is installed on the conduit; and a gas supply unit 400 for supplying external gas is connected to one side of the circulation pipe 300 connected to the inlet side of the pressure pump 100. The gas supply unit is connected to the circulation pipe 300 through a gas supply pipe 420, and a flow rate valve 431 for adjusting the gas supply amount and a check valve 441 for preventing backflow of gas or high pressure water are installed on the gas supply pipe 420. In addition, in order to further increase a gas dissolved ratio of a fluid discharged from a mixing unit 220″, a partition unit 500 having a shape illustrated in FIGS. 7 to 8 may be installed on the outlet-side conduit 203 of the multi-stage mixer 200′. In addition, although not illustrated in FIG. 10, a storage tank 600 having a configuration illustrated in FIG. 9 may be installed on part of the outlet-side conduit 203 extending beyond the partition unit 500 to store fluid that has passed through the partition unit 500 in the storage tank 600.

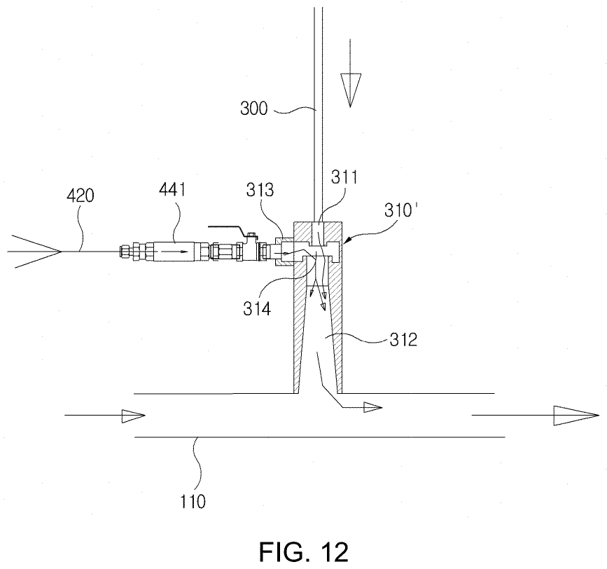

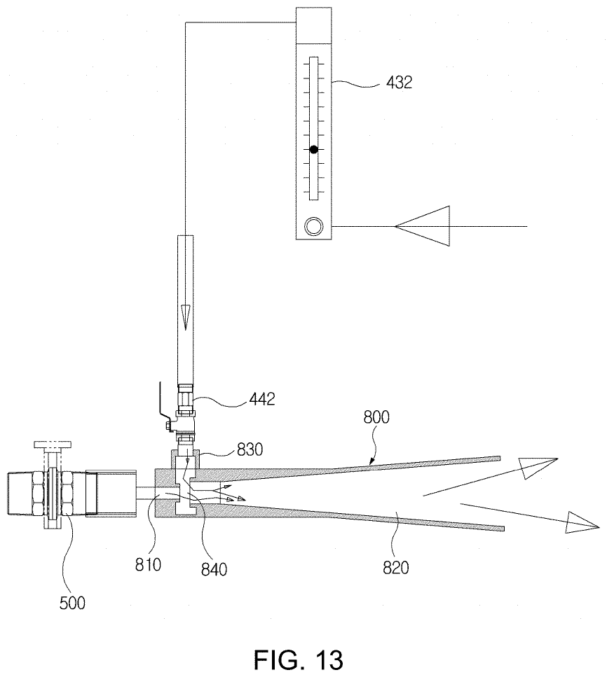

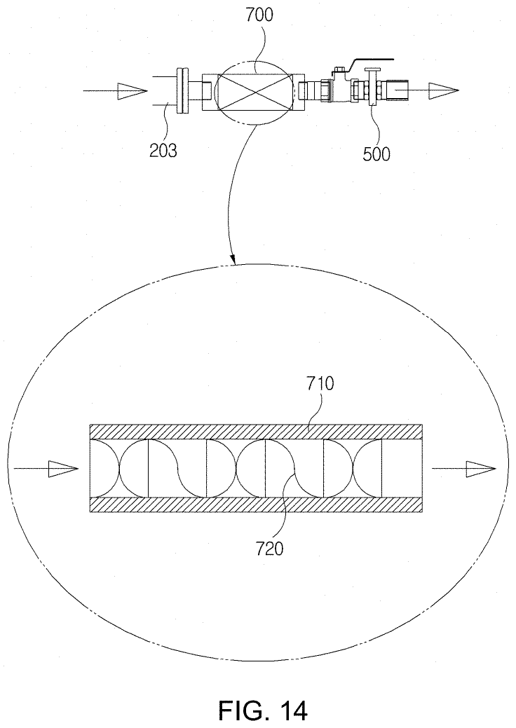

Meanwhile, in this embodiment, the connection portion of the gas supply pipe 420 and the circulation pipe 300 may be configured as a first mixing ejector 310′ (see FIG. 12), instead of the three-way valve 310 illustrated in FIGS. 1 and 9. In addition, an air vent 227 may be installed on the top of the mixing unit 220″ of the multi-stage mixer 200′ and is intended to discharge large gas bubbles from a mixed fluid within the mixing unit 220″. The vent may prevent a decrease in efficiency according to the inconsistent degree of fluid miniaturization due to the existence of large bubbles among the bubbles in the fluid. The air vent 227 may be used in connection with a separate air tank 228. Further, in the present embodiment, a quantum energy generator 700 (see FIG. 14) is additionally installed between the multi-stage mixer 200′ and the partition unit 500, and a second mixing ejector 800 (see FIG. 13) may be additionally installed on the final discharge side of the outlet-side conduit 203 extending beyond the partition unit 500.

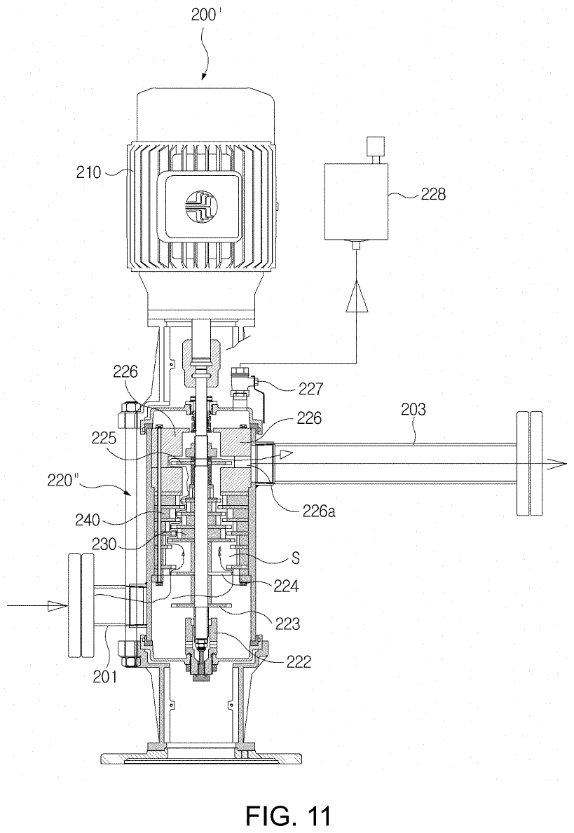

FIG. 11 is an enlarged view of the multi-stage mixer of FIG. 10 having a modified form of the mixing unit according to FIG. 2. Here, the multi-stage mixer 200′ has a plurality of teethed blades, that is, the rotor 230 and the stator 240, which correspond to each other in the shape illustrated in FIGS. 2 to 6, both on the surface of the shaft (motor shaft 211) of the motor 210 and on the inner wall surface of the housing (mixing unit 220), respectively. The multi-stage mixer 200′ repeatedly strikes air, oxygen (O₂), nitrogen (N₂), ozone (O₃) or carbon dioxide (CO₂) or the like in a mixed fluid (hereinafter referred to as ‘fluid’) supplied from the pressurize pump 100 at a high pressure, using the teethed blades. At this time, cavitation occurred in the fluid causes microbubbles to be generated, and at the time increases the gas dissolved ratio in the fluid.

Meanwhile, according to the present embodiment, a dispersion prevention housing 226 for preventing dispersion of a mixed fluid of water (or liquid) and gas may be additionally installed in a discharge-side space of the upper portion of the mixing unit 220″. The dispersion prevention housing 226 is intended to allow the fluid pressurized by the relative rotation of the rotor 230 and the stator 240 in the mixing unit 220″ to maintain the persistence without being expanded and dispersed in the process of moving to the upper outlet side. In the case of the mixing unit 220 of FIG. 1, the discharge-side space of the upper portion provided for a mixed fluid exiting a space between the rotor 230 and the stator 240 is formed wide. Therefore, the high pressure fluid finely mixed in the mixing unit expands too rapidly, resulting in a problem in which the bubble size is not uniformized, and eventually causes the efficiency of the mixed fluid to decrease in actual field application.

Therefore, in the present embodiment, the discharge-side space of the upper portion of the mixing unit 220″ is filled with a dispersion preventing housing 226 surrounding with a certain diameter. The intermediate portion 226a of the dispersion preventing housing 226 is configured to have a structure in communication with a discharge port 202 disposed at the upper portion of the mixing unit 220″ and the outlet-side conduit 203 extending therefrom. Here, the intermediate portion 226a is configured to have a space having a certain size in the circumferential direction thereof in correspondence to the discharge port 202, and it is preferable that a guide blade 225 on the motor shaft 211 for guiding a fluid flow is placed therein to be operable. This not only facilitates cavitation by the operation of the guide blade 225 in the dispersion prevention housing 226, but also further increases the gas dissolved ratio in the fluid together with the generation of bubbles by the cavitation. In this case, in order to increase a gas dissolved ratio in a fluid, it is preferable that the mixed fluid of water (or liquid) and gas is pressurized and supplied at a pressure of 4 kg/cm² or more and at the same time is miniaturized to a size less than or equal to 5 microns by a high rotation of more than a certain level of the rotor in the mixing unit 220′.

FIG. 12 is an enlarged view of the first mixing ejector of FIG. 10, which is a modified form of the three-way valve according to FIG. 1. Here, the first mixing ejector 310′ connects the gas supply pipe 420 and the circulation pipe 300 and connects them again to the inlet pipe 110 of the pressure pump. The first mixing ejector 310′ includes a short-toothed portion 311 at a location connected to the circulation pipe 300 and a long-toothed portion 312 at a location connected to the inlet side pipe 110 of the pressure pump, and the inner diameter thereof is gradually enlarged from the short-toothed portion 311 to the long-toothed portion 312. In addition, a connection portion 313 connected to the gas supply pipe 420 is formed at one side of the short-toothed portion 311 to form a space portion 314 having a predetermined size traversing the end portion of the short-toothed portion 311 from the connection portion 313. In this configuration, as water (or liquid) having a predetermined pressure or more supplied through the circulation pipe 300 from the outlet-side conduit of the pressure pump passes through the short-toothed portion 311, the pressure thereof decreases in the space portion 314 and the flow rate thereof becomes faster. As a result, a large amount of gas may be independently sucked from the gas supply pipe 420 without using a separate power source. In addition, the mixed fluid of water (or liquid) and gas that has passed through the short-toothed portion 311 primarily generates fine bubbles in the space portion 314 due to cavitation occurring therein, and it is possible to supply a larger amount of fluid to the inlet pipe 110 of the pressure pump while the mixed fluid passes through the enlarged interior of the mixing ejector 310′ that extends from the short-toothed portion to the long-toothed portion.

Meanwhile, a gas that is supplied through the gas supply pipe 420 may include air, oxygen (O₂), nitrogen (N₂), ozone (O₃), carbon dioxide (CO₂), and the like, as well as the mixture thereof, and oxygen-dissolved water, nitrogen-dissolved water, ozone-dissolved water, carbon dioxide-dissolved water, and the like may be generated according to the application.

FIG. 13 is an enlarged view of a second mixing ejector of FIG. 10 further provided in the gas-dissolved water generating apparatus of the present invention. As described above, the second mixing ejector 800 may be installed at the final end or on the discharge side of the outlet side conduit (203) extending past the partition unit 500. The second mixing ejector 800 includes a short-toothed portion 810 at a location connected to the final end or discharge side of the outlet-side conduit 203 and a long-toothed portion 820 positioned in the corresponding direction, and an inner diameter thereof is gradually enlarged from the short-toothed portion 810 to the long-toothed portion 820. In addition, the second mixing ejector 800 is connected to the gas supply pipe 420′ at one side of the short-toothed portion 810 and is connected to a gas supply unit 400 therethrough. A flow control valve 432 for adjusting the gas supply amount and a check valve 442 for preventing backflow of gas or high pressure water may be installed on the gas supply pipe 420′. The second mixing ejector 800 provides a space portion 840 having a predetermined size traversing the end portion of the short-toothed portion 810 from the connection portion 830 at one side of the short-toothed portion 810 connected to the gas supply pipe 420′. In this configuration, as a mixed fluid of water (or liquid) and gas having a predetermined pressure or more supplied from the final end or the discharge-side of the outlet-side conduit 203 passes through the short-toothed portion 810, the pressure thereof decreases in the supply portion 840 and the flow rate thereof becomes faster. As a result, a large amount of gas may be independently sucked from the gas supply pipe 420′ without using a separate power source. In addition, the mixed fluid of water (or liquid) and gas that has passed through the short-toothed portion 810 primarily generates fine bubbles in the space portion 840 due to cavitation occurring therein, and a larger amount of fluid may be discharged while the mixed fluid passes through the enlarged interior of the second mixing ejector 800 that extends from the short-toothed portion to the long-toothed portion. Meanwhile, a gas that is supplied through the gas supply pipe 420 may include air, oxygen (O₂), nitrogen (N₂), ozone (O₃), carbon dioxide (CO₂), and the like, as well as the mixture thereof, and oxygen-dissolved water, nitrogen-dissolved water, ozone-dissolved water, carbon dioxide-dissolved water, and the like may be generated according to the application.

FIG. 14 is an enlarged view of a quantum energy generator further provided in the gas-dissolved water generating apparatus of the present invention. The quantum energy generator 700 may be configured by installing one or more magnetic field coils 720 inside a pipe 710. Here, purity of active molecules such as OH-Radical, free radicals (O), and hydroxyl ions (H₂O₃—) generated by decomposing covalent bonds of water molecules by irradiating the fluid passing through the quantum energy generator 700 with quantum energy, is further increased, and the active molecules may sterilize bacteria and viruses contained in the fluid. Accordingly, the quantum energy generator may enhance the causes of water quality deterioration such as waste water and green algae. Meanwhile, in the drawings, although the quantum energy generator 700 is illustrated as being positioned between the multi-stage mixer 200′ and the partition unit 500, the present invention is not limited thereto and it goes without saying that the quantum energy generator may be disposed in the forward or backward of the partition unit 500 as necessary.

Although various embodiments of the present invention have been described above, the embodiments have been described so far are merely illustrative of some of the preferred embodiments of the present invention, and the scope of the present invention is not limited by the embodiments described above, except for the appended claims. Accordingly, it is understood that those having ordinary knowledge in the same technical field can make many changes, modifications and substitutions of equivalents without departing from the technical spirit and gist of the invention within the scope of the following claims.

What is claimed is:

1. A gas-dissolved water generating apparatus in which
a pressure pump and a multi-stage mixer are sequentially arranged on at least one conduit; a circulation pipe connecting an inlet side of the pressure pump and a outlet side of the pressure pump is positioned on the conduit; a gas supply unit for supplying a predetermined external gas to one side of the circulation pipe, which is connected to the inlet side of the pressure pump, via a gas supply pipe; the gas supply unit and the circulation pipe are connected through a three-way valve, and the three-way valve is configured to have a structure of a venturi pipe having wide inlet and outlet channels and a narrow interior channel along the circulation pipe, so that a gas supplied from the gas supply unit is independently sucked; the multi-stage mixer includes a mixing unit having a meshing structure of a rotor and a stator around a motor shaft, and the mixing unit has a space portion having a predetermined size on an inlet side, and the space portion is formed by installing at least one layer of teethed blades of a predetermined radius on the motor shaft at a position spaced a predetermined distance from a coupling portion of the rotor and stator in the mixing unit.

2. The gas-dissolved water generating apparatus according to claim 1, wherein the rotor and the stator have a multi-layer structure in which teethed blades are formed on the rotor and the stator to correspond to each other and are stacked with a constant thickness; teethed blades of the rotor and the stator includes a plurality of short-toothed portions and a plurality of long-toothed portions protruding at regular intervals between the respective short-toothed portions, respectively, and the teethed blades are continuously stacked; the long-toothed portions of the rotor correspond to the short-toothed portions of the stator, the long-toothed portions of the stator correspond to the short-toothed portions of the rotor, and teethed blades of the rotor and the stator have a coupling shape interleaved with each other at regular intervals between the ends of the long-toothed portions thereof.

3. The gas-dissolved water generating apparatus according to claim 2, wherein a fluid supplied by the pressure pump can flow from an inlet provided on one side of the lower portion of the mixing unit of the multi-stage mixer to an outlet provided on the other side of the upper portion thereof in the corresponding direction, and in order to guide this fluid flow, one or more guide blades may be disposed at positions on the motor shaft adjacent to the inlets and outlets at a predetermined distance in the vertical direction of the rotor.

4. The gas-dissolved water generating apparatus according to claim 2, wherein the mixing unit has the rotor configured in a truncated cone shape in which the radius of the long-toothed portion and the short-toothed portion is reduced stepwise, and the stator configured as an inverted truncated cone shape in which the radius of the long-toothed portion and the short-toothed portion increases stepwise in correspondence with the truncated cone-shaped rotor.

5. The gas-dissolved water generating apparatus according to claim 2, wherein the rotor has a plurality of teeth formed at regular intervals along the outer circumferential end portions of the respective teethed blades, and the stator has a plurality of teeth formed at regular intervals along the inner circumferential end portions of the respective teethed blades; the teeth formed on the outer or inner circumferential surface of the respective teethed blades of the rotor and the stator have at least one side surface of side surfaces corresponding each other during relative rotation of the rotor and the stator, the teeth having the one side surface inclined at a predetermined angle, and the respective teeth of the long-toothed portion and the short-toothed portion of the rotor have at their outer circumferential end portions grooves of a predetermined radius.

6. The gas-dissolved water generating apparatus according to claim 2, wherein a partition unit of a predetermined shape is installed on the outlet-side conduit of the multi-stage mixer to further increase a gas dissolved ratio in the fluid discharged from the mixing unit; the partition unit has at least two or more partition walls therein, one or more holes are perforated in each of these partition walls, and the holes are arranged in the front and rear partition walls not to face each other.

7. The gas-dissolved water generating apparatus according to claim 2, wherein a storage tank of a predetermined size is installed on the outlet-side conduit of the multi-stage mixer and the fluid having passed through a partition unit is stored in the storage tank; a plurality of electrode rods are installed inside the storage tank, and each of the electrode rods is connected to (+) and (−) terminals of DC power, respectively.

8. The gas-dissolved water generating apparatus according to claim 3, wherein a dispersion prevention housing is installed in a discharge-side space of the upper portion of the mixing unit, the dispersion prevention housing surrounding the space with a certain diameter and being intended to prevent excessive expansion and dispersion of the fluid, wherein the dispersion prevention housing is in communication with the outlet disposed at the upper portion of the mixing unit and an outlet-side conduit extending therefrom, and includes an intermediate portion having a space having a certain size in the circumferential direction thereof in correspondence to the outlet; and wherein a guide blade on the motor shaft for guiding a fluid flow is placed in the intermediate portion to be operable.

9. The gas-dissolved water generating apparatus according to claim 1, wherein a first mixing ejector which includes a short-toothed portion at a location connected to the circulation pipe and a long-toothed portion at a location connected to the inlet side pipe of the pressure pump is installed as a substitute for the three-way valve;
a second mixing ejector which includes a short-toothed portion at a location connected to the final end or outlet side of the outlet-side conduit and a long-toothed portion at a location in the corresponding direction of the short-toothed portion is further comprised; the first and second mixing ejectors has a structure in which an inner diameters thereof are gradually enlarged from the short-toothed portion to the long-toothed portion; and a connection portion connected to the gas supply pipe is formed at one side of the short-toothed portion to provide a space portion having a predetermined size traversing the end portion of the short-toothed portion from the connection portion.

10. The gas-dissolved water generating apparatus according to claim 1, wherein one or more quantum energy generators are installed on the outlet-side conduit between the multi-stage mixer and the partition unit, and the quantum energy generator is configured by installing one or more magnetic field coils inside a pipe.
